(19) United States
(12) Patent Application Publication
(10) Pub. No.: US 2016/0275543 A1
(43) Pub. Date: Sep. 22, 2016

(54) Time-restricted Product Sale Promotion System and Method thereof

(71) Applicants: Hai Chiang, Pingtung (TW); Shao-Yin Cheng, Pingtung (TW)

(72) Inventors: Hai Chiang, Pingtung (TW); Shao-Yin Cheng, Pingtung (TW)

(21) Appl. No.: 15/075,234

(22) Filed: Mar. 21, 2016

Related U.S. Application Data
(63) Continuation-in-part of application No. 13/902,887, filed on May 27, 2013, now abandoned.

(51) Int. Cl. G06Q 30/02

(52) U.S. Cl. CPC G06Q 30/0235; G06Q 30/0223; G06Q 30/0261

(57) ABSTRACT

A time-restricted product sale promotion system includes a promotion platform, at least one seller system, at least one buyer system and a promotion management unit. A time-restricted product sale promotion method includes: providing a time-restricted degressive mechanism on the promotion platform and connecting with a real-time price reporting system to generate a real-time price reference; a seller utilizing the mechanism to calculate optimum degressive sale prices within a restricted promotion time interval and sending the optimum degressive sale prices and the real-time price reference to a buyer; the buyer sending a purchase order to the promotion platform according to the promotion price; comparing the promotion price with the purchase order; displaying a bargain information on the promotion platform if the purchase order is verified.

### BACKGROUND OF THE INVENTION

This application is a continuation-in-part of U.S. patent application Ser. No. 13/902,887, filed May 27, 2013, which is hereby incorporated by reference in its entirety.

1. Field of the Invention

The present invention relates to a time-restricted product sale promotion system and method thereof. More particularly, the present invention relates to the time-restricted degressive product sale promotion system and method thereof.

2. Description of the Related Art

U.S. Patent Appl. Pub. No. 20080189200, entitled “Degressive Auction Method,” discloses a degressive method for an auction process comprising: offering at least one item for sale; setting an initial maximum price, a minimum price and a degressive rule; receiving bidding from buyers, and decreasing a current price according to the degressive rule until the auction is ended. A degressive auction system further disclosed comprises an input device for inputting an initial maximum price, a minimum price and a degressive rule; and a control device for receiving bidding from buyers. The control device decreases the current price according to the degressive rule until the auction is terminated.

Another U.S. Pat. No. 7,062,460, entitled “On-line Auction Method and System Facilitating the Sale of Multiple Product Units at Prices Varying with Volume,” discloses an online auction system for auctioning off products, including a server system, plural buyer systems, and plural seller systems. The server system further comprises a seller interface, a buyer interface, a price adjustment mechanism, and a bid manager. The seller interface performs an online bid setup process including obtaining, from a given seller system, price varying information and quantity information corresponding to the price varying information. The buyer interface communicates, to select buyer systems, bid information and product information, and accepts from a given buyer system a given quantity needed and a given bid. The price adjustment mechanism determines a given parity price for the given buyer, which varies according to the given quantity needed. The bid manager defines a given winning bid for the given buyer as a function of the given parity price and a rank of the given buyer in relation to other buyers.

However, the auction method or system disclosed in U.S. Patent Appl. Pub. No. 20080189200 or U.S. Pat. No. 7,062,460 exists a need of improving a conventional auction method for incorporating a total amount of sale products or incorporating a real-time price-reporting system. The above-mentioned patents are incorporated herein by reference for purposes including, but not limited to, indicating the background of the present invention and illustrating the state of the art.

As is described in greater detail below, the present invention provides a time-restricted product sale promotion system and method thereof. A degressive mechanism and a real-time price-reporting system are provided to automatically adjust and generate an optimum sale price to avoid the failure of product sale promotion in such a way to mitigate and overcome the above problem.

### SUMMARY OF THE INVENTION

The primary objective of this invention is to provide a time-restricted product sale promotion system and method thereof. A product sale promotion platform connects between a plurality of buyer systems and a plurality of seller systems for communicating sale product information. Accordingly, the time-restricted product sale promotion system and method of the present invention are successful in promoting sale products.

Another objective of this invention is to provide a time-restricted product sale promotion system and method thereof. A time-restricted degressive mechanism and a real-time price-reporting system are provided to automatically adjust and generate an optimum degressive sale price of sale products. Accordingly, the time-restricted product sale promotion system and method of the present invention are successful in outselling competitiveness sale products.

The time-restricted product sale promotion system in accordance with an aspect of the present invention includes:

a product sale promotion platform providing a time-restricted degressive mechanism and connecting with a real-time price-reporting system;

at least one seller system connected with the product sale promotion platform on which to provide at least one sale product and promotion prices thereof, thereby calculating and adjusting the promotion prices within a total restricted promotion time interval by the degressive mechanism to generate a series of optimum degressive sale prices of the sale product and a time schedule, and generating a real-time price reference from the real-time price-reporting system;

at least one buyer system connected with the product sale promotion platform to receive the optimum degressive sale prices and the real-time price reference, thereby sending out a purchase order to the seller system via the product sale promotion platform according to the selected optimum degressive sale price with the time schedule; and

a promotion management unit connected with the product sale promotion platform to receive data of the sale product, the optimum degressive sale prices and the purchase order for comparing the purchase order with the corresponding optimum degressive sale price;

wherein if the corresponding optimum degressive sale price and the purchase order are completely verified, bargain data are displayed on the product sale promotion platform.

The time-restricted product sale promotion method in accordance with another aspect of the present invention includes the steps of:

providing a time-restricted degressive mechanism on a product sale promotion platform and providing a real-time price-reporting system to connect with the product sale promotion platform;

connecting a seller system to the product sale promotion platform to provide at least one sale product and promotion prices thereof, calculating and adjusting the promotion prices within a total restricted promotion time interval by the degressive mechanism to generate a series of optimum degressive sale prices of the sale product and a time schedule, and generating a real-time price reference from the real-time price-reporting system;

sending out the optimum degressive sale prices and the real-time price reference to a buyer system;

connecting the buyer system to the product sale promotion platform to send out a purchase order to the seller system via the product sale promotion platform according to the selected optimum degressive sale price with the time schedule;

comparing the purchase order with the corresponding optimum degressive sale price by a promotion management unit; and

displaying bargain data on the product sale promotion platform if the corresponding optimum degressive sale price and the purchase order are completely verified.

In a separate aspect of the present invention, the seller system connects with the product sale promotion platform to preset at least one time interval and total times of degressive promotion by the time-restricted degressive mechanism.

In a further separate aspect of the present invention, the time-restricted degressive mechanism includes at least one correlation between degressive promotion prices and time.

In a further separate aspect of the present invention, the optimum sale prices further combines with different extra bonuses or discount coupons.

In yet a further separate aspect of the present invention, the sale product includes a combination of different promotion items which are provided to calculate a total of the promotion prices of the combination of the different promotion items, or the sale product includes a limited quantity of at least one promotion item which is provided to calculate and adjust the promotion prices of the limited quantity of the promotion items.

In yet a further separate aspect of the present invention, the promotion prices include an initial promotion price, a plurality of degressive promotion prices and a final promotion price.

In yet a further separate aspect of the present invention, the real-time price-reporting system connects with at least one shopping website or shopping center to receive real-time prices of products therefrom.

In yet a further separate aspect of the present invention, comparing the real-time price reference with the optimum degressive sale prices for generating a differential price table between the real-time price reference and the optimum degressive sale prices.

In yet a further separate aspect of the present invention, the time schedule has degressive time intervals to compact a promotion time step by step.

In yet a further separate aspect of the present invention, the time schedule has at least one extended time interval to extend a promotion time or at least one shortened time interval to surprisingly shorten a promotion time.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic block diagram of a time-restricted product sale promotion system in accordance with a preferred embodiment of the present invention.

FIG. 2 is schematic diagrams of degressive promotion tables with different correlations between promotion prices and time and a differential price table applied in the time-restricted product sale promotion system and method in accordance with a preferred embodiment of the present invention.

FIG. 2A is a chart illustrating sale prices in relation to time of a degressive mechanism applied in the time-restricted product sale promotion system and method in accordance with the preferred embodiment of the present invention.

FIG. 3 is a flow chart of the time-restricted product sale promotion method in accordance with a first preferred embodiment of the present invention.

FIG. 4 is a flow chart of the time-restricted product sale promotion method in accordance with a second preferred embodiment of the present invention.

FIG. 5 is a schematic block diagram of a time-restricted product sale promotion system in accordance with a third preferred embodiment of the present invention.

FIG. 6 is a schematic block diagram of a time-restricted product sale promotion system in accordance with a fourth preferred embodiment of the present invention.

FIG. 7 is a flow chart of the time-restricted product sale promotion method in accordance with the third and fourth preferred embodiments of the present invention.

FIG. 8 is a chart illustrating discount rates in relation to time of a dynamic discount calculation mechanism applied in the time-restricted product sale promotion system and method in accordance with the third and fourth preferred embodiments of the present invention.

FIG. 9 is a schematic view of a time-restricted product sale promotion system in accordance with a fifth preferred embodiment of the present invention.

### DETAILED DESCRIPTION OF THE INVENTION

It is noted that a time-restricted product sale promotion system and method in accordance with the preferred embodiments of the present invention are suitable for various Internet trading systems or e-shop systems, for example: on-line shopping systems, which are not limitative of the present invention. The time-restricted product sale promotion system and method in accordance with the preferred embodiment of the present invention are further suitable for various e-commence systems, for example: O2O, B2B or B2C e-commence systems, which are not limitative of the present invention.

The time-restricted product sale promotion system and method in accordance with the preferred embodiment of the present invention are implemented by computer-executable steps on various computer equipment, for example: desktop computers, laptop computers, workstation computers, etc. Furthermore, the time-restricted product sale promotion system and method in accordance with the preferred embodiment of the present invention can be operated or accessed via various network systems, for example: Internet, local area networks (LAN), or various wireless local area networks (wireless LAN), which are not limitative of the present invention.

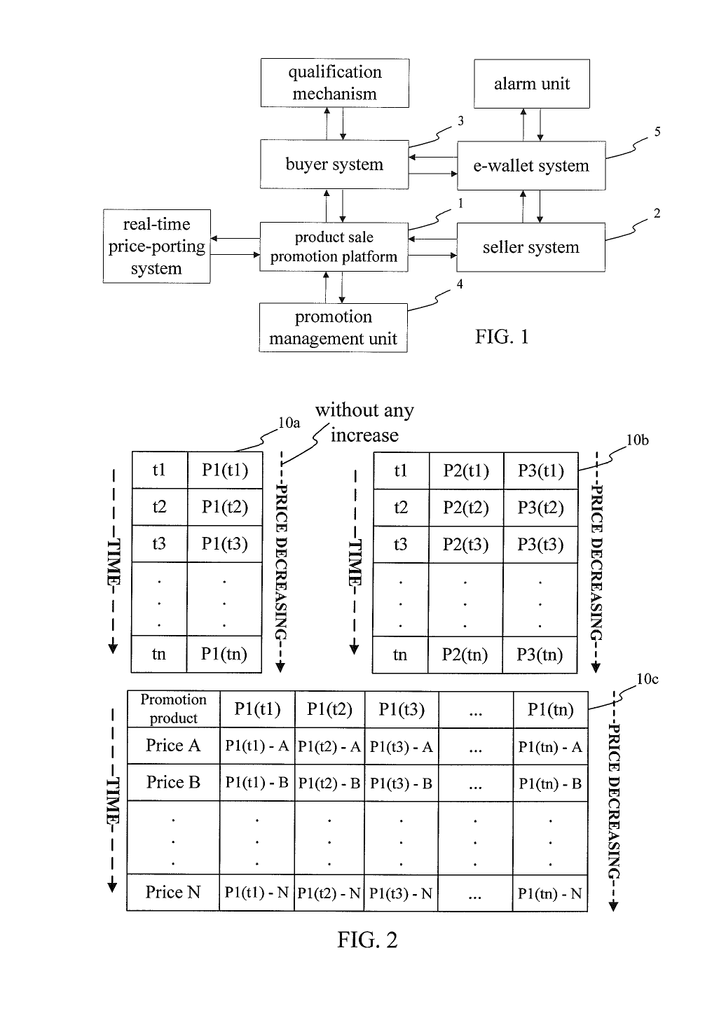

FIG. 1 shows six schematic blocks to describe the time-restricted product sale promotion system in accordance with a preferred embodiment of the present invention. Referring to FIG. 1, the time-restricted product sale promotion system in accordance with the preferred embodiment of the present invention includes a product sale promotion platform 1, a plurality of seller systems 2, a plurality of buyer systems 3, a promotion management unit 4 and other units (e.g. quantity-limited calculation mechanism, qualification mechanism, alarm unit or real-time price-reporting system) which are connected. The number of the seller systems 2 and the buyer systems 3 can be increased or reduced according to the need.

Preferably, the product sale promotion platform 1 is provided in a server computer or the like. The seller systems 2 and the buyer systems 3 are selected from various computer systems (e.g. desktop computers) or various mobile communication devices, for example: laptop computers, sub-notebook computers or netbook computers, tablet computers or smart phones. In a preferred embodiment, each buyer should have a bank account (or e-wallet) with a predetermined minimum deposit for joining the time-restricted product sale promotion system, and, therefore, the bank account is automatically checked by the qualification mechanism in determining the amount of purchase prior to sending out each purchase order. By way of example, the minimum deposit may be 30% or more of the total amount of the purchase order, initial promotion prices or original prices. If the total amount of the purchase order is less than the minimum deposit, no purchase order can be successfully sent out in the time-restricted product sale promotion system and will be considered as unqualified.

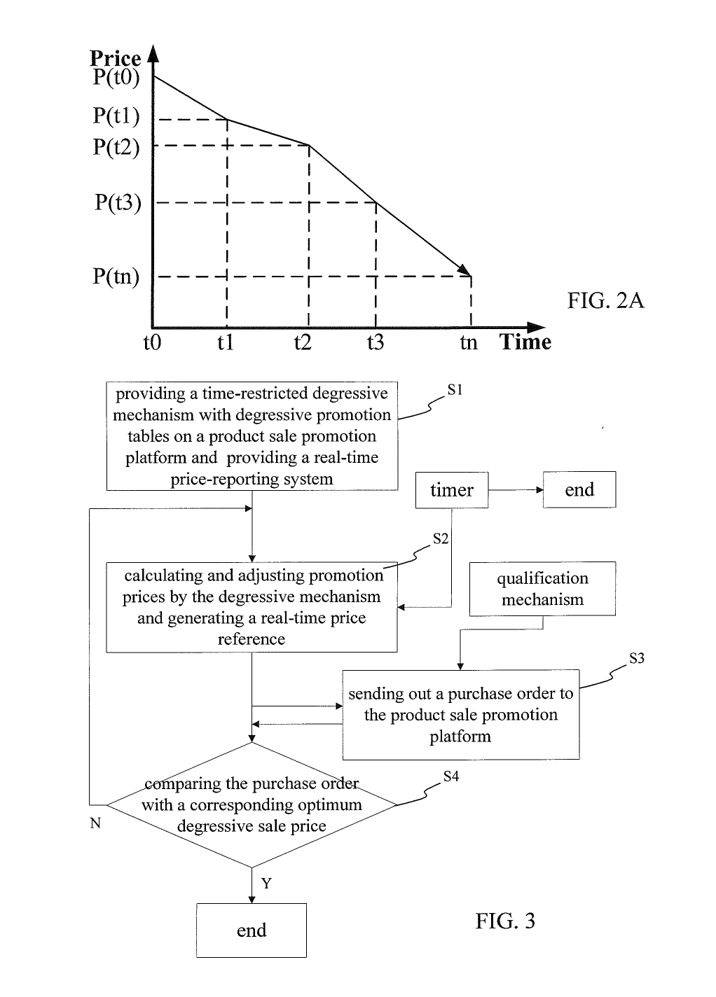

FIG. 2 shows two degressive promotion tables each of which has a correlation between promotion prices and time applied in the time-restricted product sale promotion system, as best shown in FIG. 1, in accordance with the preferred embodiment of the present invention. Referring to FIGS. 1 and 2, the product sale promotion platform 1 of the present invention includes a server unit provided with a degressive mechanism and a real-time price-reporting system. By way of example, the degressive mechanism is executed to generate a plurality of degressive promotion tables 10a and 10b with different correlations between degressive promotion prices and time, as shown in FIG. 2. The degressive promotion tables 10a and 10b, each of which has a correlation between promotion prices and time, are applied to preset various time intervals and total times of degressive promotion for sale products by sellers, so that the product sale promotion platform 1 can generate a series of optimum sale prices of sale products and a time schedule.

With continued reference to FIG. 2, for example, the degressive promotion table 10a, which is designated to a single sale product, includes a time schedule of t1, t2, t3 . . . tn corresponding to the optimum sale prices P1(t1), P1(t2), P1(t3) . . . P1(tn) which is preferably calculated by a degressive equation. In an alternative embodiment, the optimum sale prices P1(t1), P1(t2), P1(t3) . . . P1(tn) further combine with different extra bonuses or discount coupons which are provided by the same seller or different sellers. The degressive promotion table 10b, which is designated to a combination of two or more sale products, includes a time schedule of t1, t2, t3 . . . tn corresponding to the optimum sale prices P2(t1), P2(t2), P2(t3) . . . P2(tn) of the first sale product and corresponding to the optimum sale prices P3(t1), P3(t2), P3(t3) . . . P3(tn) of the second sale product.

Still referring to FIGS. 1 and 2, the product sale promotion platform 1 will receive updated prices (e.g. Price A, Price B . . . and Price N) from the real-time price-reporting system to generate a real-time price reference. The product sale promotion platform 1 is operated to compare the real-time price reference with the optimum degressive sale prices for generating a differential price table 10c between the real-time price reference and the optimum degressive sale prices (e.g. P1(t1)−Price A, P1(t2)−Price A, P1(t3)−Price A . . . P1(tn)−Price A), as best shown in FIG. 2.

The time schedule has a constant time interval which can be preset by a seller. In a preferred embodiment, the time schedule has degressive time intervals to compact a promotion time step by step. For example, the time interval (t2−t1) is larger than that of (t3−t2). In an alternative embodiment, the time schedule has at least one extended time interval to extend a promotion time or at least one shortened time interval to surprisingly shorten a promotion time.

FIG. 2A shows a chart illustrating sale prices in relation to time of a degressive mechanism applied in the time-restricted product sale promotion system and method in accordance with the preferred embodiment of the present invention corresponding to FIG. 2. Referring to FIGS. 2 and 2A, by way of example, the discount prices are decreasing with P(t0)>P(t1)>P(t2)>P(t3)>P(tn) calculated with various discount rates as the time count down to tn. In a preferred embodiment, the discount rates increase as the time of the time-restricted product sale promotion starts to count down. In another preferred embodiment, provided between any two prices (P(t0), P(t1), P (t2), P(t3), . . . P(tn)) is a straight-line decline in the time-restricted product sale promotion.

Referring back to FIG. 1, the seller system 2 connects with the product sale promotion platform 1 on which to provide at least one sale product (e.g. electronic devices, fruits or flowers), quantity and promotion prices thereof. The product sale promotion platform 1 automatically connects with the real-time price-reporting system, thereby generating a real-time price reference from the real-time price-reporting system. The product sale promotion platform 1 is automatically operated to calculate and adjust the promotion prices within a total restricted promotion time interval by the degressive mechanism to generate a series of optimum degressive sale prices of the sale product and a time schedule, as best shown in FIG. 2. The promotion prices include an initial promotion price, a plurality of degressive promotion prices and a final promotion price which can be preset via the seller system 2.

In a preferred embodiment, the seller system 2 is operated to automatically send out the optimum degressive sale prices and the real-time price reference via the product sale promotion platform 1 to the predetermined buyer system 3, or the product sale promotion platform 1 is controlled to automatically send out the optimum degressive sale prices and the real-time price reference to the predetermined buyer system 3.

By way of example, the sale product may be a limited quantity of at least one promotion item or a promotion item with a due date or an expiration date. The product sale promotion will be automatically ended if the limited quantity of the promotion items sells out, the expiration date is due or the time of the total restricted promotion time interval runs out.

Still referring to FIG. 1, the buyer system 3 connects with the product sale promotion platform 1 to receive the optimum degressive sale prices, the real-time price reference and other commercial information (e.g. advertisement). Accordingly, the buyer system 3 is operated to send out a purchase order to the seller system 2 via the product sale promotion platform 1 according to the selected optimum degressive sale price with the time schedule. In an alternative, the product sale promotion platform 1 will be automatically processed a verification procedure with the buyer system 3 in response to the purchase order.

With continued reference to FIG. 1, the promotion management unit 4 connects with the product sale promotion platform 1 to receive data of the sale product, the optimum degressive sale prices and the purchase order for comparing the purchase order with the corresponding optimum degressive sale price. If the corresponding optimum degressive sale price and the purchase order are completely verified, bargain data is displayed on the product sale promotion platform 1.

FIG. 3 shows a flow chart of the time-restricted product sale promotion method executed by the time-restricted product sale promotion system, as shown in FIG. 1, in accordance with the first preferred embodiment of the present invention. Referring again to FIGS. 1, 2 and 3, the time-restricted product sale promotion method in accordance with the first preferred embodiment of the present invention includes the step S1: providing the time-restricted degressive mechanism with the degressive promotion tables 10a or 10b on the product sale promotion platform 1 and further providing the real-time price-reporting system to connect with the product sale promotion platform 1. Accordingly, the product sale promotion platform 1 will be operated to obtain the real-time price reference (i.e. promotion prices shown in catalogues or on-line advertisements of other brands) from the real-time price-reporting system. For example, the real-time price-reporting system connects with at least one shopping website or shopping center to receive real-time prices of products therefrom.

With continued reference to FIGS. 1, 2 and 3, the time-restricted product sale promotion method in accordance with the first preferred embodiment of the present invention includes the step S2: connecting the seller system 2 to the product sale promotion platform 1 to provide at least one sale product, quantity and promotion prices thereof by a seller. The product sale promotion platform 1 is operated to obtain the real-time price reference from the real-time price-reporting system which can be observed by the seller system 2. The product sale promotion platform 1 is operated to calculate and adjust the promotion prices within the total restricted promotion time interval (e.g. 10 minutes) by the degressive mechanism. The differences of the optimum degressive sale prices (e.g. P1(t2)−P1(t1), P1(t3)−P1(t1) or P1(tn)−P1(t1)), the differences between the original price and the optimum degressive sale prices, or the differences between the real-time price reference and the optimum degressive sale prices are calculated. Consequently, a series of the optimum degressive sale prices of the sale product and the time schedule are generated in the product sale promotion platform 1.

Referring back to FIG. 2, for example, the optimum degressive sale prices include an initial promotion price P1(t1), a plurality of degressive promotion prices P1(t2), P1(t3) and a final promotion price P1(tn). The seller can utilize the degressive promotion tables 10a or 10b to preset and execute the initial promotion price, the degressive promotion prices and the final promotion price on the product sale promotion platform 1. When the promotion prices are completely calculated, the product sale promotion platform 1 is operated to start a timer to count down for the time-restricted product sale promotion.

Referring again to FIGS. 1 and 3, the time-restricted product sale promotion method in accordance with the alternative preferred embodiment of the present invention further includes the step: sending out the optimum degressive sale prices and the real-time price reference to the predetermined buyer system 3. In an alternative embodiment, the seller can connect with the buyer system 3, other online shopping centers or online stores via the product sale promotion platform 1 to notify the optimum degressive sale prices of the sale product, the time schedule and the real-time price reference by emails or text messages.

Referring again to FIGS. 1 and 3, the time-restricted product sale promotion method in accordance with the first preferred embodiment of the present invention includes the step S3: connecting the buyer system 3 to the product sale promotion platform 1 to send out a purchase order to the seller system 2 via the product sale promotion platform 1 by a buyer according to the selected optimum degressive sale price with the time schedule. Accordingly, the promotion management unit 4 will receive the data of the purchase order and the corresponding optimum degressive sale price from the product sale promotion platform 1. In a preferred embodiment, the qualification mechanism is automatically operated to generate a fee schedule of a minimum amount of deposit for each of the initial promotion step, the degressive promotion steps and the final promotion step in the beginning of the promotion. Prior to sending out a purchase order, the method further includes the step: automatically comparing the predetermined minimum deposit (calculated from the total amount of the purchase order) with the balance of the bank account by the qualification mechanism for qualification of the buyer.

Still referring to FIGS. 1, 2 and 3, the time-restricted product sale promotion method in accordance with the first preferred embodiment of the present invention includes the step S4: automatically comparing the purchase order with the corresponding optimum degressive sale price by the promotion management unit 4 to generate successful bargain data. The product sale promotion platform 1 will be operated to display the bargain data on the product sale promotion platform if the corresponding optimum degressive sale price and the purchase order are completely verified. Consequently, the successful bargain data is recorded and further sent to the seller system 2 and the buyer system 3 by emails or text messages. In a preferred embodiment, the purchase order cannot be cancelled, and the payment is non-refundable if the purchase order is verified.

Referring again to FIG. 1, the seller and the buyer can use an e-wallet system 5 for collection of payments (i.e. electronically inward remittance or outward remittance) while operating the product sale promotion platform 1. When the seller or the buyer is authorized to use the e-wallet system 5, the inward remittance, outward remittance and extra bonuses are remitted to designated bank accounts of the seller system 2 and the buyer system 3.

With continued reference to FIG. 1, the product sale promotion platform 1 further includes an alarm unit. By way of example, the alarm unit will generate an alarm signal to the product sale promotion platform 1, the seller system 2 and the buyer system 3 if the e-wallet system 5 is abnormal, overdraft or is inappropriately used by shopaholics.

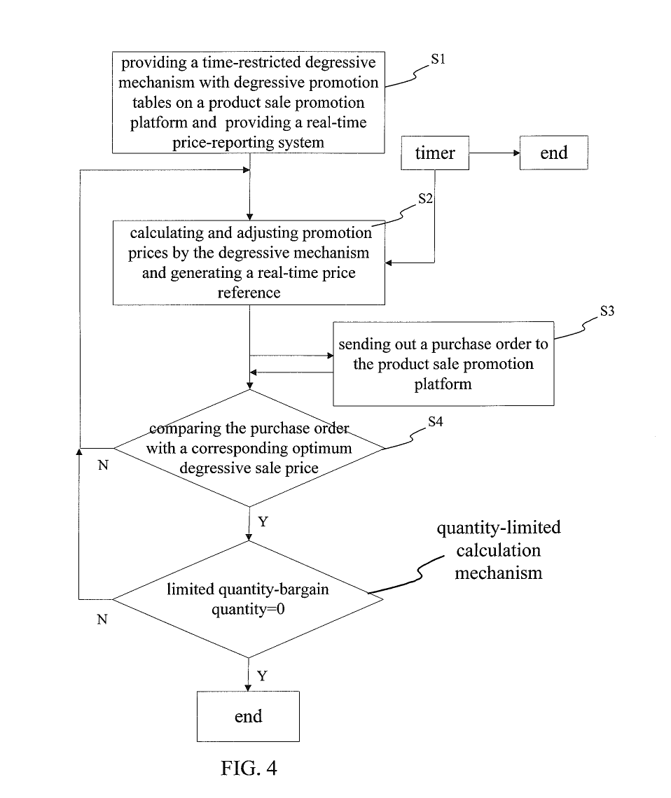

FIG. 4 shows another flow chart of the time-restricted product sale promotion method in accordance with the second preferred embodiment of the present invention similar to that shown in FIG. 3. Referring to FIGS. 1 and 4, the time-restricted product sale promotion method in accordance with the second preferred embodiment of the present invention further includes the step: comparing a limited quantity of the sale products with a successful bargain quantity of the sale products to decide continuing or terminating the time-restricted product sale promotion.

Still referring to FIGS. 1 and 4, by way of example, the promotion management unit 4 is operated to subtract the successful bargain quantity from the limited quantity of the sale products. If the result is greater than zero, the time-restricted product sale promotion will be automatically continued. Conversely, if the result is equal to or smaller than zero, the time-restricted product sale promotion will be automatically terminated.

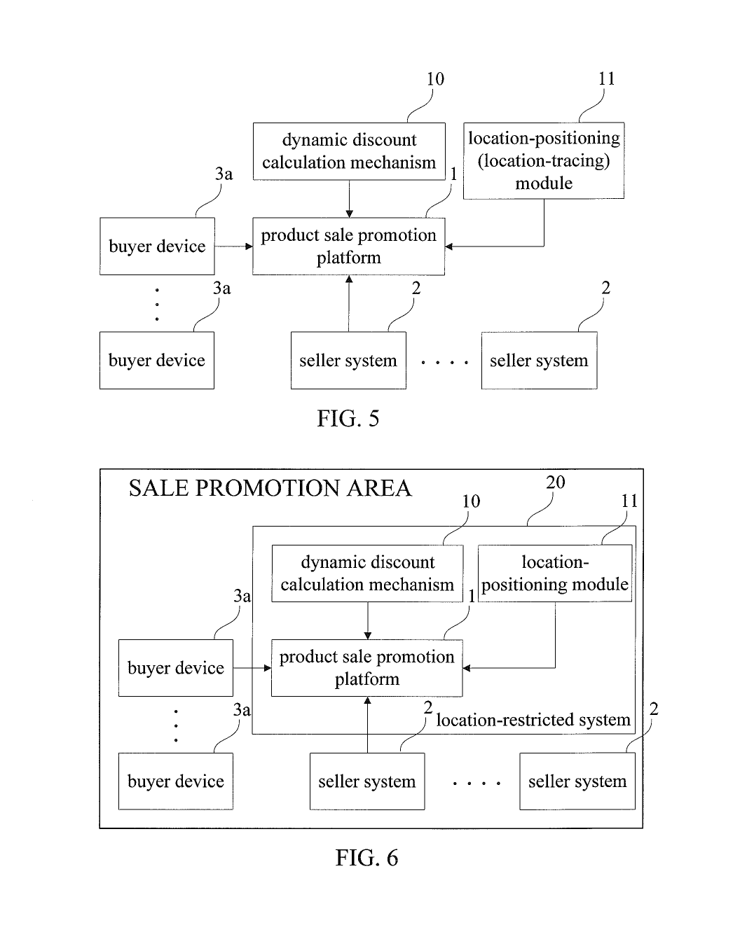

FIG. 5 shows a schematic block diagram of a time-restricted product sale promotion system in accordance with a third preferred embodiment of the present invention. Referring now to FIG. 5, the time-restricted product sale promotion system in accordance with the third preferred embodiment of the present invention includes a product sale promotion platform 1, a plurality of seller systems 2, a plurality of buyer devices (computer devices or mobile communication devices) 3a and other units (e.g. promotion management unit, quantity-limited calculation mechanism, qualification mechanism, alarm unit or real-time price-reporting system) which are connected. The product sale promotion platform 1 further includes a dynamic discount calculation mechanism 10 and a location-positioning (location-tracing) module 11 connected with a GPS module, a wireless communication module, a RFID module, an indoor-positioning module or other equivalent outdoor-indoor-positioning module. In another preferred embodiment, the dynamic discount calculation mechanism 10 or the location-positioning (location-tracing) module 11 is provided in the promotion management unit 4.

FIG. 6 shows a schematic block diagram of a time-restricted product sale promotion system in accordance with a fourth preferred embodiment of the present invention corresponding to those shown in FIGS. 1 and 5. Referring now to FIG. 5, in comparison with the third embodiment, the time-restricted product sale promotion system in accordance with the fourth preferred embodiment of the present invention is a location-restricted product sale promotion system 20, including a product sale promotion platform 1, a dynamic discount calculation mechanism 10 and a location-positioning module 11 and is suitable for a predetermined sale promotion area. In a preferred embodiment, the predetermined sale promotion area is a department store region, a hypermarket region, a shopping center region, a mall region, a country area, an internet-based promotion area, a special economic zone, a free trade zone or the like. In another preferred embodiment, the dynamic discount calculation mechanism 10 is combined with the degressive mechanism for receiving a series of discount rates.

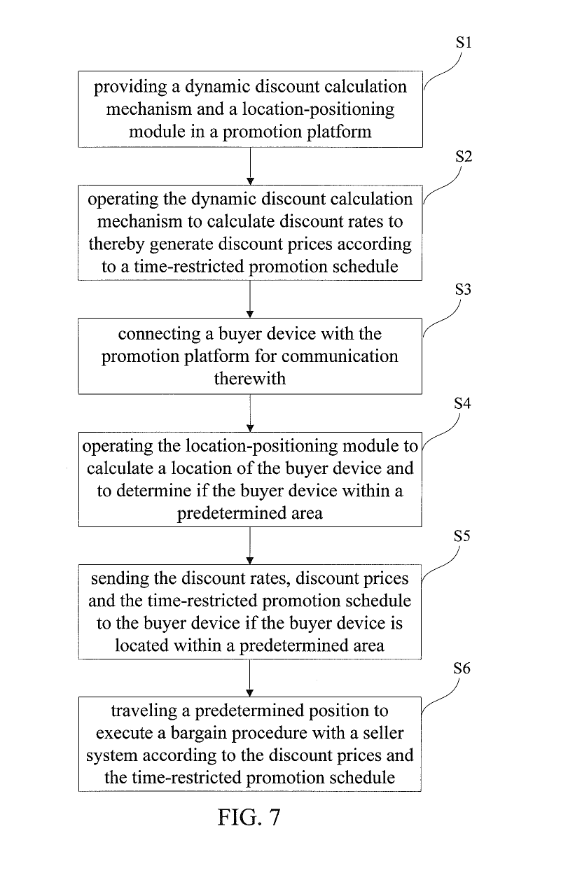

FIG. 7 shows a flow chart of the time-restricted product sale promotion method in accordance with the third and fourth preferred embodiments of the present invention corresponding to the time-restricted product sale promotion system shown in FIGS. 5 and 6. Referring to FIGS. 5, 6 and 7, the time-restricted product sale promotion method in accordance with the third and fourth preferred embodiments of the present invention includes the step S1: providing the dynamic discount calculation mechanism 10 and the location-positioning module 11 in the product sale promotion platform 1. In a preferred embodiment, the time-restricted product sale promotion method further includes the step: connecting the seller system 2 to the product sale promotion platform 1 to provide at least one sale product, quantity and promotion prices thereof by a seller.

With continued reference to FIGS. 5, 6 and 7, the time-restricted product sale promotion method in accordance with the third and fourth preferred embodiments of the present invention includes the step S2: operating the dynamic discount calculation mechanism 10 as a discount-rate degressive mechanism to calculate a plurality of discount rates to thereby generate discount prices according to a time-restricted promotion schedule. In a preferred embodiment, the time-restricted product sale promotion method further executes the real-time price-reporting system to connect with at least one shopping website or shopping center to receive real-time prices of products therefrom. Furthermore, the product sale promotion platform 1 is firstly operated to start a timer to count down a first predetermined time interval for the whole time-restricted product sale promotion.

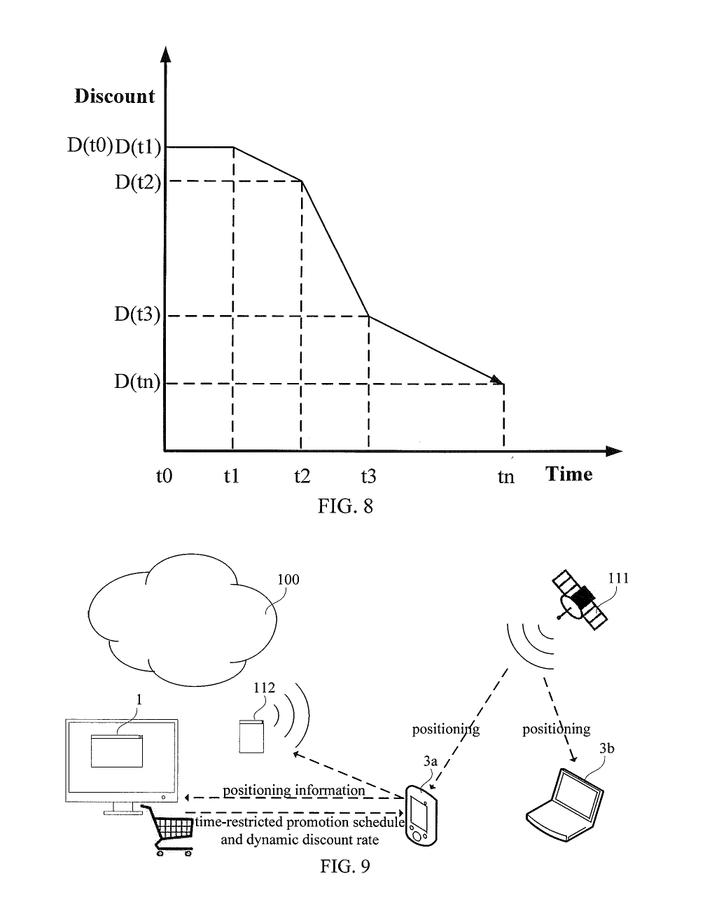

FIG. 8 shows a chart illustrating discount rates in relation to time of a dynamic discount calculation mechanism applied in the time-restricted product sale promotion system and method in accordance with the third and fourth preferred embodiments of the present invention. Referring to FIG. 8, by way of example, the dynamic discount calculation mechanism includes a plurality of time-varying discount rates or time-decreasing discount rates D(t0), D(t1), D(t2), D(t3), D(t4), . . . D(tn) corresponding to a time schedule of t0, t1, t2, t3, t4, . . . tn, where D(t0)=D(t1)>D(t2)>D(t3)>D(tn). In a preferred embodiment, the discount rates D(t0), D(t1), D(t2), D(t3), . . . D(tn) for the customers can be changed to an amount of equivalent-value bonus products or discount coupons within the time interval (t0−tn). In another preferred embodiment, provided between any two discount rates (D(t0), D(t1), D(t2), D(t3), D(t4), . . . D(tn)) is a straight-line decline.

Referring again to FIGS. 5, 6 and 7, the time-restricted product sale promotion method in accordance with the third and fourth preferred embodiments of the present invention includes the step S3: automatically connecting a number of the previously-listed buyer devices 3a with the product sale promotion platform 1 for communication therewith. In a preferred embodiment, a member or priority list (or file) of customers is provided with the product sale promotion platform 1.

In a preferred embodiment, customers can connect with the product sale promotion platform 1 or the seller systems 2 with the buyer device 3a via a predetermined interface (e.g., App.) when they browse on the Internet, attend a product-launching ceremony, drive on the street, get hairdressing, go shopping in a shopping center etc. Accordingly, the locations (e.g., IP addresses, GPS information or mailing address) of the customers with the buyer device 3a can be simultaneously confirmed by the product sale promotion platform 1 or the promotion management unit 4.

With continued reference to FIGS. 5, 6 and 7, the time-restricted product sale promotion method in accordance with the third and fourth preferred embodiments of the present invention includes the step S4: starting and operating the location-positioning module 11 to calculate or to position a location of the buyer device 3a and to determine if the buyer device 3a within a predetermined area when a buyer responds to the product sale promotion platform 1. Accordingly, the buyer can respond the product sale promotion platform 1 with an email, a voice message, a text message, online access (e.g., mutual authentication) or other equivalent manner.

With continued reference to FIGS. 5, 6 and 7, the time-restricted product sale promotion method in accordance with the third and fourth preferred embodiments of the present invention includes the step S5: sending the discount rates, the discount prices, the time-restricted promotion schedule and other information (e.g., deadline or time limit) to the buyer device 3a for inviting the customer and accelerating a personal time-restricted product sale promotion if the buyer device is located within the predetermined area. Conversely, the personal time-restricted product sale promotion for the buyer device 3a will be terminated once the buyer device 3a departs from the predetermined area.

Advantageously, the customer will win or acquire a higher discount rate by the product sale promotion platform 1 if an order is made faster and earlier. In a preferred embodiment, the product sale promotion platform 1 is secondly operated to start the timer to count down a second predetermined time interval for the personal time-restricted product sale promotion within the first predetermined time interval.

With continued reference to FIGS. 5, 6 and 7, the time-restricted product sale promotion method in accordance with the third and fourth preferred embodiments of the present invention includes the step S7: allowing a buyer to travel to a predetermined position to execute a bargain procedure with the seller system 2 within the second predetermined time interval according to the discount rates, the discount prices and the time-restricted promotion schedule. The discount rates and discount prices for the personal will be revoked if the second predetermined time interval is completely ended or the whole time-restricted product sale promotion is terminated. In a preferred embodiment, the predetermined position is a restaurant, a bar, a retailer store, a convenience store, a department store, a hypermarket, a shopping center, a mall, a restaurant car, a vehicle, a depot, a train, a station, a boat, a ship (or a liner), a harbor, a plane, an airport, a vending machine or other equivalent equipment.

Referring again to FIGS. 5, 6, 7 and 8, in the first degressive promotion period (t0−t1), the discount rates D(t0) and D(t1) are constant, 45% or 50% off for example. The personal time-restricted product sale promotion for the buyer device 3a will be terminated within the time period (t0−t1) if any bargain procedure is successfully completed by the buyer at the predetermined position and is confirmed by the product sale promotion platform 1 with the seller system 2.

With continued reference to FIGS. 5, 6, 7 and 8, subsequently, in the second degressive promotion period (t1−t2), the discount rate starts gradually dropping to D(t2) (i.e., 40% off) from D(t1) with a first decreasing rate. As previously described, the personal time-restricted product sale promotion for the buyer device 3a will also be terminated within the time period (t1−t2) if any bargain procedure is successfully completed by the buyer at the predetermined position and is confirmed by the product sale promotion platform 1 with the seller system 2.

With continued reference to FIGS. 5, 6, 7 and 8, subsequently, in the third degressive promotion period (t2−t3), the discount rate rapidly drops to D(t3) (i.e., 20% off) from D(t2) with a second decreasing rate. As previously described, the personal time-restricted product sale promotion for the buyer device 3a will also be terminated within the time period (t2−t3) if any bargain procedure is successfully completed by the buyer at the predetermined position and is confirmed by the product sale promotion platform 1 with the seller system 2.

With continued reference to FIGS. 5, 6, 7 and 8, subsequently, in the final degressive promotion period (t3−tn), the discount rate changes from a rapid drop to a normal drop as well as dropping from D(t3) to D(tn) (i.e., 15%, 10% or 5% off) with a third decreasing rate. As previously described, the personal time-restricted product sale promotion for the buyer device 3a will also be terminated within the time period (t3−tn) if any bargain procedure is successfully completed by the buyer at the predetermined position and is confirmed by the product sale promotion platform 1 with the seller system 2.

FIG. 9 shows a schematic view of a time-restricted product sale promotion system in accordance with a fifth preferred embodiment of the present invention corresponding to those shown in FIGS. 1, 5 and 6. Referring to FIGS. 5, 6, 7, 8 and 9, by way of example, the product sale promotion platform 1 is provided in a cloud server 100, a computer server, or other equivalent device. The location-positioning module 11 connects with a GPS system 111 and an indoor-positioning system 112 to position the location of the buyer device 3a. In a preferred embodiment, the location-positioning module 11 further connects with a map system (e.g., Google Map system) to calculate a travel time of the customer to the predetermined position, including a stroll time, a normal traffic time and a rush traffic time, for successfully executing the bargain procedure.

Referring again to FIG. 9, by way of example, the product sale promotion platform 1 selectively sends the information to the buyer device 3a rather than a candidate buyer device 3b which is not located within the predetermined area or at a further travel distance. As previously described, the personal time-restricted product sale promotion for the buyer device 3a will be terminated once the buyer device 3a departs from the predetermined area. In a preferred embodiment, the product sale promotion platform 1 turns to sending the information to the candidate buyer device 3b for substitution if the buyer device 3a certainly departs from the predetermined area.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A time-restricted product sale promotion system comprising:
a first device including a product sale promotion platform providing a time-restricted degressive mechanism and connecting with a real-time price-reporting system, with the time-restricted degressive mechanism including at least one correlation between degressive promotion prices and time;
a location-positioning module being provided in the product sale promotion platform to determine a predetermined sale promotion area;
at least one second device including a seller system connected with the product sale promotion platform on which to provide a sale product and promotion prices thereof, with the product sale promotion platform calculating and adjusting the promotion prices within a total restricted promotion time interval by the time-restricted degressive mechanism to generate a series of optimum degressive sale prices of the sale product and a time schedule, and generating a real-time price reference from the real-time price-reporting system;
at least one third device including a buyer system connected with the product sale promotion platform to receive the series of optimum degressive sale prices and the real-time price reference, with the buyer system sending out a purchase order to the seller system via the product sale promotion platform according to a selected optimum degressive sale price with the time schedule; and
a promotion management unit connected with the product sale promotion platform to receive data of the sale product, the series of optimum degressive sale prices and the purchase order for comparing the purchase order with the selected optimum degressive sale price;
wherein the product sale promotion platform is operated to determine whether a position of the third device is located within a predetermined area.

2. The time-restricted product sale promotion system as defined in claim 1, wherein the seller system connects with the product sale promotion platform to preset at least one time interval and total times of degressive promotion by the time-restricted degressive mechanism.

3. The time-restricted product sale promotion system as defined in claim 1, wherein the time-restricted degressive mechanism includes at least one correlation between degressive promotion prices and time.

4. The time-restricted product sale promotion system as defined in claim 1, wherein the time-restricted degressive mechanism provides a plurality of degressive promotion prices including a series of a firstly-decreasing price P(t1), a secondly-decreasing price P(t2) and a finally-decreasing price P(tn) with degressive differences P(t2)−P(t1) and P(tn)−P(t1) calculated by a degressive equation; and wherein the plurality of degressive promotion prices starts at the firstly-decreasing price P(t1), drops to the secondly-decreasing price P(t2) and finally drops to the finally-decreasing price P(tn).

5. The time-restricted product sale promotion system as defined in claim 4, wherein the plurality of degressive promotion prices further includes a thirdly-decreasing price P(t3) provided between the secondly-decreasing price P(t2) and the finally-decreasing price P(tn) with a degressive difference P(t3)−P(t1); and wherein the plurality of degressive promotion prices starts at the firstly-decreasing price P(t1), drops to the secondly-decreasing price P(t2), further drops to the thirdly-decreasing price P(t3) and finally drops to the finally-decreasing price P(tn).

6. The time-restricted product sale promotion system as defined in claim 1, wherein when the selected optimum degressive sale price and the purchase order are completely verified, bargain data is displayed on the product sale promotion platform; wherein the promotion management unit compares a limited or reserved quantity of the sale product with a successful bargain quantity of the sale product to continue or terminate a time-restricted product sale promotion process by subtracting the successful bargain quantity from the limited or reserved quantity; and wherein the promotion management unit subtracts the successful bargain quantity from the limited or reserved quantity and continues when a result is greater than zero or terminates if the result equals or is smaller than zero.

7. The time-restricted product sale promotion system as defined in claim 1, wherein the promotion management unit compares the real-time price reference with the series of optimum degressive sale prices for generating a differential price table between the real-time price reference and the series of optimum degressive sale prices.

8. The time-restricted product sale promotion system as defined in claim 1, wherein the location-positioning module is operated to calculate or to position a location of the third device.

9. The time-restricted product sale promotion system as defined in claim 1, wherein the location-positioning module connects with a GPS system and an indoor-positioning system to position the location of the third device.

10. The time-restricted product sale promotion system as defined in claim 1, wherein the time-restricted degressive mechanism is combined with a dynamic discount calculation mechanism to receive a series of time-varying or time-decreasing discount rates.

11. A time-restricted product sale promotion method comprising the steps of:
providing a first device including a time-restricted degressive mechanism and a location-positioning module on a product sale promotion platform and providing a real-time price-reporting system to connect with the product sale promotion platform;
connecting a second device including a seller system to the product sale promotion platform to provide at least one sale product and promotion prices thereof, calculating and adjusting the promotion prices within a total restricted promotion time interval by the time-restricted degressive mechanism to generate a series of optimum degressive sale prices of the sale product and a time schedule, and generating a real-time price reference from the real-time price-reporting system;
operating the location-positioning module to determine a predetermined sale promotion area for the product sale promotion platform, with further operating the product sale promotion platform to determine whether a position of the third device is located within a predetermined area;
sending out the optimum degressive sale prices and the real-time price reference to the third device including a buyer system when the third device is located within the predetermined area;
connecting the buyer system to the product sale promotion platform to send out a purchase order to the seller system via the product sale promotion platform according to a selected optimum degressive sale price with the time schedule;
comparing the purchase order with the selected optimum degressive sale price by a promotion management unit.

12. The time-restricted product sale promotion method as defined in claim 11, wherein the time-restricted degressive mechanism provides a plurality of degressive promotion prices including a series of a firstly-decreasing price P(t1), a secondly-decreasing price P(t2) and a finally-decreasing price P(tn) with degressive differences P(t2)−P(t1) and P(tn)−P(t1) calculated by a degressive equation; wherein the plurality of degressive promotion prices starts at the firstly-decreasing price P(t1), drops to the secondly-decreasing price P(t2) and finally drops to the finally-decreasing price P(tn).

13. The time-restricted product sale promotion method as defined in claim 12, wherein the plurality of promotion prices further includes a thirdly-decreasing price P(t3) provided between the secondly-decreasing price P(t2) and the finally-decreasing price P(tn) with a degressive difference P(t3)−P(t1); and wherein the plurality of degressive promotion prices starts at the firstly-decreasing price P(t1), drops to the secondly-decreasing price P(t2), further drops to the thirdly-decreasing price P(t3) and finally drops to the finally-decreasing price P(tn).

14. The time-restricted product sale promotion method as defined in claim 11, further comprising displaying bargain data on the product sale promotion platform when the corresponding optimum degressive sale price and the purchase order are completely verified; comparing a limited or reserved quantity of the sale product with a successful bargain quantity of the sale product to continue or terminate a time-restricted product sale promotion process by subtracting the successful bargain quantity from the limited or reserved quantity; and subtracting the successful bargain quantity from the limited or reserved quantity and continuing when a result is greater than zero or terminating if the result equals or is smaller than zero.

15. A time-restricted product sale promotion method comprising:
providing a first device including a dynamic discount calculation mechanism and a location-positioning module on a product sale promotion platform, with the dynamic discount calculation mechanism including a plurality of time-varying discount rates;
connecting a second device including a seller system to the product sale promotion platform to provide at least one sale product and promotion prices thereof, calculating and adjusting the promotion prices within a total restricted promotion time interval by the dynamic discount calculation mechanism to generate a series of sale prices of the sale product and a time schedule with the plurality of time-varying discount rates;
operating the location-positioning module to determine a predetermined sale promotion area for the product sale promotion platform, with further operating the product sale promotion platform to determine whether a position of the third device is located within a predetermined area;
sending out the sale prices with the plurality of time-varying discount rates to the third device including a buyer system when the third device is located within the predetermined area;
connecting the buyer system to the product sale promotion platform to send out a purchase order to the seller system via the product sale promotion platform according to a selected sale price with the time schedule;
comparing the purchase order with the selected sale price by a promotion management unit.

16. The time-restricted product sale promotion method as defined in claim 15, further connecting the location-positioning module with a map system to calculate a travel time of the customer to the predetermined position.

17. The time-restricted product sale promotion method as defined in claim 15, wherein when a buyer responds to the product sale promotion platform, the location-positioning module starts to calculate or to position the location of the third device.

18. The time-restricted product sale promotion method as defined in claim 15, further comprising at least one of a GPS system and an indoor-positioning system to connect with the location-positioning module to position the location of the third device.

19. The time-restricted product sale promotion method as defined in claim 15, further terminating a time-restricted product sale promotion for the buyer device when the third device departs from the predetermined area; and further sending out the sale prices with the plurality of time-varying discount rates to another third device for substitution.

20. The time-restricted product sale promotion method as defined in claim 15, further operating the third device to respond the product sale promotion platform with an email, a voice message, a text message or online access.
